(19) United States
(12) Patent Application Publication
(10) Pub. No.: US 2005/0077865 A1
(43) Pub. Date: Apr. 14, 2005

(54) Portable computing device peripheral employing fuel cell to recharge battery

(75) Inventors: Dennis Alan Durbin, Cedar Rapids, IA (US); Thomas J. Schuster, Cedar Rapids, IA (US); Brad McDermott, Marion, IA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Intermec IP Corp., Everett, WA (US)

(21) Appl. No.: 10/926,570

(22) Filed: Aug. 26, 2004

Related U.S. Application Data
(60) Provisional application No. 60/497,758, filed on Aug. 26, 2003.

(51) Int. Cl. H02J 7/00

(52) U.S. Cl. 320/101

(57) ABSTRACT

A peripheral device is provided for a portable computing device that includes a rechargeable battery, operating circuitry powered by the rechargeable battery, and a fuel cell coupled to provide charging current to the rechargeable battery. Battery charging circuitry is operatively coupled to the rechargeable battery and the fuel cell to control charging of the rechargeable battery by the fuel cell.

### CROSS-REFERENCE TO RELATED APPLICATION(S)

This application claims the benefit of U.S. Provisional Application No. 60/497,758 filed Aug. 26, 2003 for “Extended Operation of Portable Battery Operated Intermittent Duty Cycle High Power Devices Using Fuel Cell Technology” by D. Durbin, T. Schuster and B. McDermott.

### INCORPORATION BY REFERENCE

The aforementioned U.S. Provisional Application No. 60/497,758 is hereby incorporated by reference in its entirety.

### BACKGROUND OF THE INVENTION

The present invention relates to portable computing devices with a peripheral employing a fuel cell to provide extended operation capability.

Portable electronic data collection and computing devices have become more and more popular for use in a variety of industries. These industries continually demand devices that are more lightweight and energy efficient. A major portion of the weight of portable devices is made up of the batteries that power them.

Three common objectives for the batteries employed in portable electronic devices are to reduce the weight of the batteries (thereby reducing overall product weight), to extend product operation for a given volume or weight of the batteries or other power source, and to provide increased performance and flexibility in recharging the batteries. Typically, batteries achieve increased product operational time by employing battery chemistries that provide higher power density in the same volume. Lithium-Ion chemistry is the current state of the art. Recharging batteries typically requires time (overnight) or expensive circuitry to monitor fast charging. Also, access to other power sources is necessary, usually charging stations powered from wall supplies (docking stations) or vehicular mounted docks. All of these charging devices are generally not directly associated with the product's use, but are a necessary function that is performed at a time least disruptive to the user's tasks. Also, all extra batteries (spares) have to be recharged during this time and usually require their own docking stations.

There are a number of varied battery operated portable products tailored to the needs of particular applications. As these products provide more and more performance, they also become more “power hungry.” There is continual demand for products that provide additional performance in a package that weighs less and lasts for an entire working day.

Fuel cell technology, such as a Direct Methanol Fuel Cell (DMFC), is lighter and has a much higher energy density than the Lithium-Ion chemistry. However, the current level of fuel cell technology does not allow the DMFC to deliver high current pulses on demand, and therefore cannot completely replace batteries in most portable applications.

There is a continuing need in the art to provide improvements in operation time and power density, and to reduce product weight, in portable computing devices.

### BRIEF SUMMARY OF THE INVENTION

The present invention is a peripheral device provided for a portable computing device that includes a rechargeable battery, operating circuitry powered by the rechargeable battery, and a fuel cell coupled to provide charging current to the rechargeable battery. Battery charging circuitry is operatively coupled to the rechargeable battery and the fuel cell to control charging of the rechargeable battery by the fuel cell.

### BRIEF DESCRIPTION OF THE DRAWINGS

FIG. 1A is a perspective view, and

FIG. 1B is an exploded perspective view, of a portable computing device having a powered radio frequency identification (RFID) peripheral, employing fuel cell driven battery charging in accordance with an embodiment of the present invention.

FIG. 2 is a functional block diagram of the portable computing device and powered RFID peripheral employing a fuel cell for battery charging shown in FIGS. 1A and 1B.

FIG. 3 illustrates an example of a fork lift mounted device employing a fuel cell according to an embodiment of the present invention.

### DETAILED DESCRIPTION

Although fuel cell technology, such as a Direct Methanol Fuel Cell (DMFC), is not able to deliver the current necessary to fully operate most portable computing devices, the inventors have devised a system for employing fuel cell technology in portable computing devices that allows an increase in the overall energy density of the power system of the device. The inventive system is based on the fact that for many portable computing devices, certain peripherals or sub-systems employed with the device (or occasionally the device itself) require high peak current for short periods only, with rest time between those periods. Many of these types of products operate on a relatively light duty cycle, such as 10 minutes “ON” and 30 minutes “OFF.” These peripherals or sub-systems can use a much smaller battery to supply the high peak current if it can be recharged during those rest periods. A fuel cell is able to provide sufficient current for battery charging in this manner. The introduction of a small, lightweight fuel cell and reduced battery size allows the overall size of the portable device to be decreased. The need to carry spare batteries is greatly reduced, and recharging of the fuel cell is immediate by filling the cell with more methanol. The fuel cell itself requires essentially no recharging time. Its operation is similar to an automobile engine and its gas tank; the fuel cell can simply be filled with fuel and it is ready to operate. The methanol that runs the fuel cell is lighter and has much more energy per unit volume and weight than current battery technologies.

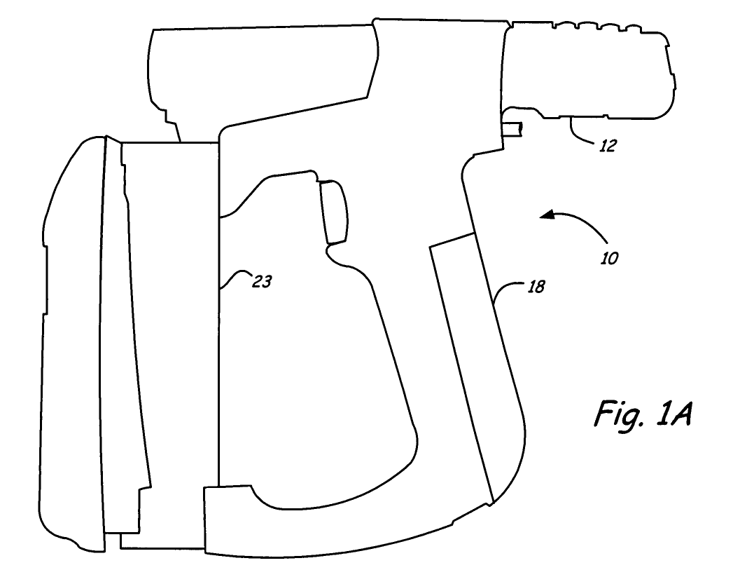

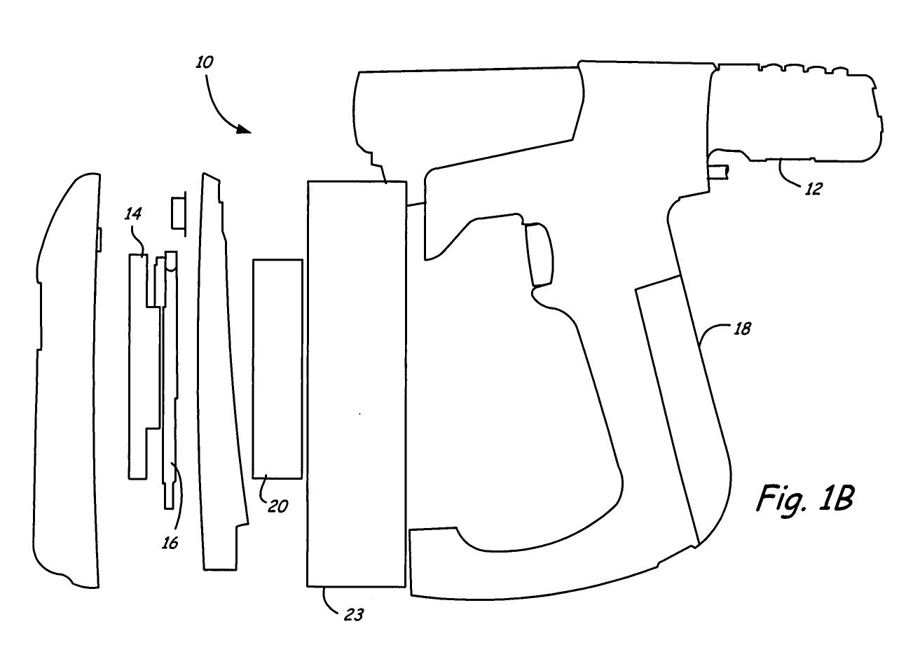

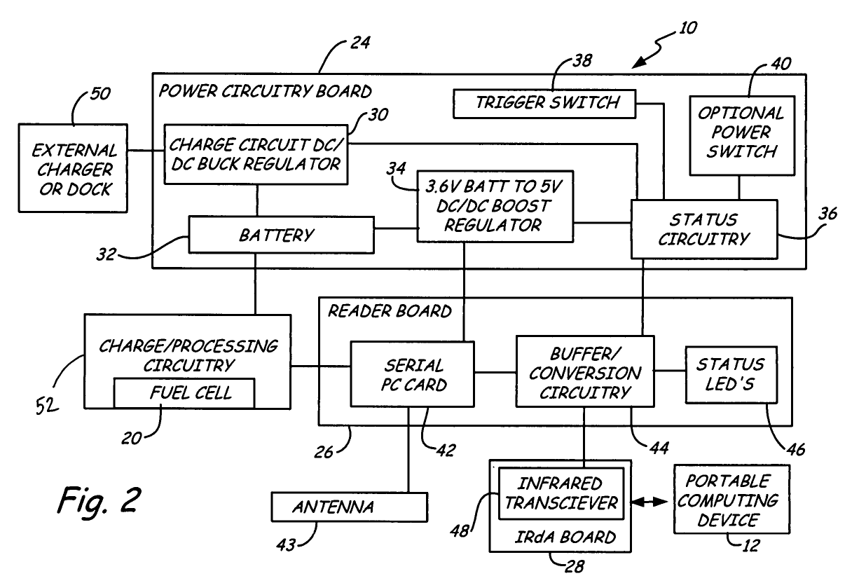

FIG. 1A is a perspective view, and FIG. 1B is an exploded perspective view, of a portable computing device having a powered radio frequency identification (RFID) peripheral, employing fuel cell driven battery charging in accordance with an embodiment of the present invention. FIG. 2 is a functional block diagram of the RFID peripheral employing a fuel cell for battery charging. RFID peripheral device 10 is operatively connected to portable computer terminal 12. RFID peripheral device 10 includes antenna 14, PC card 16 housing the circuitry for operating antenna 14 to perform radio frequency identification functions, battery 18, fuel cell 20, and fuel cell gas tank 22 (forming part of fuel cell 20). Fuel cell 20 is housed in fuel cell case 23. These components operate together as shown in the block diagram of FIG. 2.

As shown in FIG. 2, RFID peripheral device 10 includes power circuitry board 24, reader board 26 and IrDA board 28, each having a number of functional components. Power circuitry board includes charge circuit DC/DC buck regulator 30, battery 32, DC/DC boost regulator 34, status circuitry 36, trigger switch 38 and optional power switch 40. Reader board 26 includes serial PC card 42 connected to antenna 43, buffer/conversion circuitry 44 and status LEDs 46. IrDA board 28 includes infrared transceiver 48 for communicating with portable computer terminal 12. RFID peripheral device 10 includes fuel cell 20 when equipped according to the present invention, and also may be connected to external charger/dock 50.

In operation, portable computer terminal 12 is operated by a user for a particular application. In the course of this operation, peripheral device 10 is employed. Structurally, peripheral device 10 may take any number of forms. In an exemplary embodiment, peripheral device 10 is an RFID device configured as a handle, as shown in FIG. 1. Peripheral device 10 communicates with portable computer terminal 12 via infrared transceiver 48.

Peripheral device 10 is powered by battery 32, which delivers operating current to DC/DC boost regulator 34 in order to provide power to status circuitry 36 and serial PC card 42. Conventionally, battery 32 is rechargeable by connecting device 10 to external charger/dock 50, which provides recharging current to charge circuit DC/DC buck regulator 30 in order to charge battery 32. However, in accordance with the present invention, battery 32 may instead or additionally be charged by a current delivered from fuel cell 20, which may be removably located internal to peripheral device 10 in an exemplary embodiment. Fuel cell 20 includes charging and processing circuitry (not shown) that allows it to properly operate to charge battery 32, and also to communicate with serial PC card 42 to provide status information and the like. This information may be displayed by status LEDs 46 or by the connected portable computer terminal 10 in an exemplary embodiment.

There are a number of advantages to providing on-board battery charging of peripheral device 10 with fuel cell 20. Peripheral device 10, for a given weight (which is affected by the size of battery 32), can be operated for a longer period of time. Charging time between uses is also dramatically reduced, since replentishment of fuel cell 20 can be done very quickly by adding more fuel to the cell. The need for spare battery packs, previously required because of the inability of the battery to provide power for a full shift of work, can be eliminated due to the ability of fuel cell 30 to charge battery 32 during the shift in real time, while the peripheral device is not actively drawing current. The elimination of spare battery packs further reduces the overall weight that needs to be carried by a user.

Peripheral device 10 has been shown as an RFID peripheral, because of this particular peripheral's need for its own battery to provide sufficient power for operation (the battery of portable computer terminal 12 cannot provide sufficient power without significantly degrading its battery life). In other embodiments, peripheral device 10 may perform other functions, such as optical scanning, radio frequency communication (such as by a Bluetooth or other type of transceiver), or any other of a number of desirable peripheral functions known in the art. Peripheral device 10 may also utilize fuel cell 20 to at least partially recharge the battery of portable computer terminal 12, through an appropriate physical interface (not shown in FIG. 2). In an alternative embodiment, peripheral device 10 may have no separate function other than to provide a fuel cell module for recharging the battery of portable computer terminal 12, for applications where portable computer terminal 12 operates with a sufficiently light duty cycle that time is available between periods of high power operation for the fuel cell to recharge the main battery.

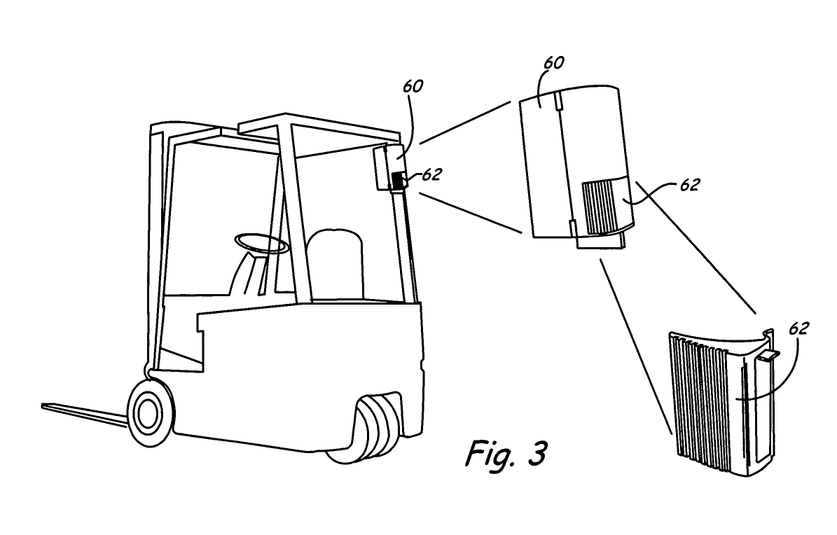

FIG. 3 illustrates an example of fork lift mounted device 60 employing fuel cell 62 according to an embodiment of the present invention. Device 60 is mounted to a structural component of a fork lift, in a manner similar to products known in the art, and includes wireless communication capability, such as a Bluetooth transceiver, to communicate data with a data collection device such as an RFID reader or an optical scanner, for example. Device 60 also has the capability of communicating information with a portable computing device or another constituent of a communication network. In prior products of this type, device 60 either required a wired connection to provide power for operating the device or was equipped with a rechargeable battery that had to be plugged into a charger or replaced when it ran out. The provision of fuel cell 62 eliminates this necessity, by allowing device 60 to recharge its battery during periods of inactivity simply by receiving charging current from fuel cell 62. In a mobile environment such as a warehouse where a fork lift is used, this capability is quite convenient for a user and results in increased worker productivity.

Although the present invention has been described with reference to preferred embodiments, workers skilled in the art will recognize that changes may be made in form and detail without departing from the spirit and scope of the invention.

1. A peripheral device for a portable computing device, comprising:
a rechargeable battery;
operating circuitry powered by the rechargeable battery;
a fuel cell coupled to provide charging current to the rechargeable battery; and
battery charging circuitry operatively coupled to the rechargeable battery and the fuel cell to control charging of the rechargeable battery by the fuel cell.

2. The peripheral device of claim 1, wherein the fuel cell is a Direct Methanol Fuel Cell (DMFC).

3. The peripheral device of claim 1, wherein the operating circuitry controls operation of a radio frequency identification (RFID) reader.

4. The peripheral device of claim 1, wherein the operating circuitry controls operation of a wireless transceiver.

5. The peripheral device of claim 1, wherein the operating circuitry controls operation of an optical scanner.

6. The peripheral device of claim 1, further comprising communication circuitry for communicating with the portable computing device.

7. The peripheral device of claim 6, wherein the communication circuitry effects communication with the portable computing device via an infrared transceiver.

8. The peripheral device of claim 1, wherein the battery charging circuitry communicates with the operating circuitry to convey information related to the status of battery charging.

9. The peripheral device of claim 8, wherein the battery charging circuitry communicates with the operating circuitry via a serial link.

10. The peripheral device of claim 8, further comprising at least one status indicator for indicating the status of battery charging.

11. A portable computing device comprising:
processing circuitry;
a communication interface; and
a peripheral device comprising:
a rechargeable battery;
operating circuitry powered by the rechargeable battery, including communication circuitry for communicating data with the processing circuitry via the communication interface;
a fuel cell coupled to provide charging current to the rechargeable battery; and
battery charging circuitry operatively coupled to the rechargeable battery and the fuel cell to control charging of the rechargeable battery by the fuel cell.

12. The portable computing device of claim 11, wherein the fuel cell is a Direct Methanol Fuel Cell (DMFC).

13. The portable computing device of claim 11, wherein the operating circuitry controls operation of a radio frequency identification (RFID) reader.

14. The portable computing device of claim 11, wherein the operating circuitry controls operation of a wireless transceiver.

15. The portable computing device of claim 11, wherein the operating circuitry controls operation of an optical scanner.

16. The portable computing device of claim 11, wherein the communication interface is an infrared link and the communication circuitry is an infrared transceiver.

17. The peripheral device of claim 11, wherein the battery charging circuitry communicates with the operating circuitry to convey information related to the status of battery charging.

18. The peripheral device of claim 17, wherein the battery charging circuitry communicates with the operating circuitry via a serial link.

19. The peripheral device of claim 17, further comprising at least one status indicator for indicating the status of battery charging.
